(19) United States
(12) Patent Application Publication
(10) Pub. No.: US 2015/0302622 A1
(43) Pub. Date: Oct. 22, 2015

(54) WEATHER INFORMATION DISPLAY SYSTEM, HUMAN NAVIGATION DEVICE, AND METHOD OF DISPLAYING WEATHER INFORMATION

(71) Applicant: Furuno Electric Co., Ltd., Nishinomiya (JP)

(72) Inventors: Yoshiaki Takechi, Nishinomiya-shi (JP); Masahiro Minowa, Nishinomiya-shi (JP)

(73) Assignee: Furuno Electric Co., Ltd., Nishinomiya (JP)

(21) Appl. No.: 14/417,782

(22) PCT Filed: Jun. 11, 2013
(86) PCT No.: PCT/JP2013/066051

§ 371 Date: Jan. 27, 2015

(30) Foreign Application Priority Data
Jul. 31, 2012 (JP) 2012-170074

(51) Int. Cl. G06T 11/60; G09B 29/00; G01W 1/10

(52) U.S. Cl. CPC G06T 11/60; G01W 1/10; G09B 29/006; G06T 2210/64

(57) ABSTRACT

A weather information display that system includes a radar device, a radar image creator, a predictor, an arrival time calculator, an encountering image creator, and a display unit. The radar device acquires weather observation data. The radar image creator creates a weather radar image based on the weather observation data. The predictor predicts a change of weather when a time point is shifted forward, based on the weather observation data. The encountering image creator creates, as the weather radar images for respective locations, an encountering image displaying the weather radar images at arrival time points at the respective locations, based on the change of weather predicted by the predictor and either one of the arrival time points at the respective locations and required periods of time to reach the respective locations. The display unit displays the encountering image by superimposing it on a map.

TECHNICAL FIELD

This disclosure relates to a weather information display system, which displays weather information by superimposing it on a map.

### BACKGROUND ART

Conventionally, as disclosed in Patent Documents 1 to 3, car navigation systems configured to superimpose weather information on a map have been known.

A map display device of Patent Document 1 acquires weather information indicating current and future weather, rainfall probabilities, etc., from a weather information center every fixed interval (e.g., everyday). The map display device can display, for example, weather around the map display device by superimposing it on a map, based on the received weather information. Moreover, the map display device can display, not only a current position of the map display device and current weather, but also a future position of the map display device, future weather, etc., by superimposing them on the map.

A navigation device of Patent Document 2 acquires weather information similar to that described above through an FM broadcast. The navigation device can display current and future weather and the like by superimposing them on a map, and can also create a route that does not encounter rain, by taking the future weather and the like into consideration.

A reception processing device of Patent Document 3 acquires weather information similar to that described above through a data broadcast and can display the weather information by superimposing it on a map.

### REFERENCE DOCUMENTS OF CONVENTIONAL ART

### Patent Document(s)

Patent Document 1: JP2003-121172A

Patent Document 2: JP2000-258174A

Patent Document 3: JP2005-051748A

### DISCLOSURE OF THE INVENTION

### Problems to be Solved by the Invention

Meanwhile, in Patent Documents 1 and 2, the current weather, etc. can be displayed; however, a transition of the weather at respective locations (e.g., a moving direction of a rain cloud) from the displayed view cannot be determined. Therefore, it has been difficult to determine which moving direction does not include encountering the rain.

Moreover, in Patent Documents 1 and 2, although the future weather and the like can also be displayed, in the displayed view, only the future position of the device in a case of moving along a predetermined route is displayed. Therefore, it has not been able to determine at a glance whether the rain can be avoided in a case of moving on a different route.

In this regard, in Patent Document 2, a route that does not encounter rain can be created automatically. However, with this configuration, the rain is not certainly avoidable for the following reasons. Specifically, in Patent Document 2, the weather information for a long period (e.g., one day) is acquired before use and then utilized. Therefore, this weather information contains weather information which was predicted quite a while ago, and thus, the weather may be contrary to the prediction. Moreover, such kind of weather information is only provided per wide area (e.g., per city), and therefore, pinpoint weather indicating a location in the relevant city where the rain falls cannot be grasped. Therefore, the conventional configurations have not been able to answer a demand of wanting to surely avoid the rain.

This disclosure is made in view of the above situations and aims to provide a weather information display system, which can accurately and instantly determine whether a user encounters rain.

### SUMMARY AND EFFECTS OF THE INVENTION

Problems to be solved by the present disclosure are described above, and means for solving the problems and effects thereof will be described below.

According to a first aspect of this disclosure, a weather information display system having the following configuration is provided. Specifically, the weather information display system includes a radar device, a radar image creator, a predictor, an encountering image creator, and a display unit. The radar device acquires weather observation data. The radar image creator creates a weather radar image based on the weather observation data. The predictor predicts a change of weather when a time point is shifted forward, based on the weather observation data. The encountering image creator creates, as the weather radar images for respective locations, an encountering image displaying the weather radar images at arrival time points at the respective locations, based on the change of weather predicted by the predictor and either one of the arrival time points at the respective locations and required periods of time to reach the respective locations. The display unit is provided to a terminal device and displays the encountering image by superimposing it on a map.

Thus, a user can grasp, only at a glance, which moving direction allows avoiding the encounter with rain, etc. Moreover, by superimposing on the map the radar image instead of a weather forecast, pinpoint weather information can be provided to the user in real time.

The weather information display system preferably has the following configuration. Specifically, the weather information display system includes a calculator configured to calculate the either one of the arrival time points at the respective locations and the required time periods to reach the respective locations in a case of moving in a predetermined direction from a reference position at a set speed. The encountering image creator creates the encountering image based on the change of weather predicted by the predictor and the either one of the arrival time points and the required time periods calculated by the calculator.

As above, either one of the arrival time points and the required time periods can be calculated, and therefore, for example, even when setting (parameter) for obtaining the encountering image is changed, the encountering image after the setting is changed can be obtained easily.

With the weather information display system, the encountering image creator may create the encountering image for all directions with respect to the reference position.

Thus, the user can grasp more detailed information, and therefore, the encounter with the rain, etc. can more surely be avoided.

The weather information display system preferably has the following configuration. Specifically, the weather information display system includes a plurality number of the radar devices. Moreover, the weather information display system includes a management unit configured to receive either one of the weather observation data and information obtained based on the weather observation data from the plurality number of the radar devices, and transmit the either one of the weather observation data and the information obtained based on the weather observation data, in response to a request from the terminal device.

Thus, compared to a configuration in which the radar device and the terminal device perform a direct communication with each other, an integrated management can be performed.

With the weather information display system, the calculator is preferably able to accept a change of the moving speed from the reference position, for the creation of the encountering image. The encountering image creator is preferably able to create the encountering image based on the accepted moving speed.

Thus, the system can respond to both of cases where the user walks and rides on a bicycle, for example.

With the weather information display system, the calculator is preferably able to accept a change of the reference position, for the creation of the encountering image. The encountering image creator is preferably able to create the encountering image based on the accepted reference position.

Thus, the system can respond to various cases, such as a case where the user arrives at a station and walks to a destination from the station.

With the weather information display system, the calculator is preferably able to accept a change of the time point of starting the movement, for the creation of the encountering image. The encountering image creator is preferably able to create the encountering image based on the accepted time point.

Thus, the system can respond to various cases, such as a case where the user departs for a destination 10 minutes after a concerned time point.

The weather information display system preferably has the following configuration. Specifically, the terminal device includes a position acquirer provided to the terminal device and configured to acquire a position of the terminal device. The encountering image creator creates the encountering image by using the position acquired by the position acquirer as the reference position.

Thus, the user can grasp pinpoint weather information around him/her in real time.

With the weather information display system, the display unit preferably displays, for each of the locations, at least one of a distance from the reference position, the required time period from the reference position, and the arrival time point.

Thus, in how many minutes the user encounters the rain, etc. can be understood, and therefore, the rain, etc. can more surely be avoided.

The weather information display system preferably has the following configuration. Specifically, the weather information display system includes a GNSS device configured to receive signals from GNSS satellites. The predictor predicts a change of the weather radar image when the time point is shifted forward, based on a detection result of the GNSS device and a detection result of the radar device.

Thus, an amount of water contained within air can be understood based on delay amounts of the signals from the GNSS satellites, etc. Therefore, a more accurate prediction can be performed.

According to a second aspect of this disclosure, a human navigation device having the following configuration is provided. Specifically, the human navigation device includes a communication unit, a position acquirer, and a display unit. The communication unit receives, as weather radar images for respective locations, an encountering image displaying the weather radar images at arrival time points at the respective locations based on a change of weather when a time point is shifted forward and either one of the arrival time points at the respective locations and required periods of time to reach the respective locations, the encountering image created based on weather observation data acquired by a radar device. The position acquirer acquires a position of the human navigation device. The display unit uses the position acquired by the position acquirer as a reference position to display the reference position and the encountering image around the reference position by superimposing them on a map.

Thus, a user can grasp, only at a glance, which moving direction allows avoiding the encounter with rain, etc. by using the human navigation device.

According to a third aspect of this disclosure, a program of displaying weather information having the following configuration is provided. The program of displaying the weather information includes causing a computer to receive, as weather radar images for respective locations, an encountering image displaying weather radar images at arrival time points at the respective locations based on a change of weather when a time point is shifted forward and either one of the arrival time points at the respective locations and required periods of time to reach the respective locations, the encountering image created based on weather observation data acquired by a radar device. The program includes causing a computer to acquire a position of the device. The program includes causing a computer to use, as a reference position, the position acquired by the acquiring the position to display the reference position and the encountering image around the reference position by superimposing them on a map.

Thus, a user can grasp, only at a glance, which moving direction allows avoiding the encounter with rain, etc. by executing the program with a smartphone, etc.

According to a fourth aspect of this disclosure, the following method of displaying weather information is provided. Specifically, the method of displaying the weather information includes acquiring weather observation data. The method includes creating a weather radar image based on the weather observation data. The method includes predicting a change of the weather radar image when a time point is shifted forward, based on the weather observation data. The method includes creating, as the weather radar images for respective locations, an encountering image displaying the weather radar images at arrival time points at the respective locations, based on the change of weather predicted by the predicting the change of the weather radar image and either one of the arrival time points at the respective locations and required periods of time to reach the respective locations. The method includes displaying the encountering image by superimposing it on a map.

Thus, a user can grasp, only at a glance, which moving direction allows avoiding the encounter with rain, etc.

### BRIEF DESCRIPTION OF DRAWINGS

FIG. 1 is a block diagram illustrating an overall configuration of a weather information display system.

FIG. 2 is a view illustrating a rainfall intensity image.

FIG. 3 is a view illustrating a rain encounter image.

FIG. 4 is a view illustrating another rain encounter image.

### MODE(S) FOR CARRYING OUT THE INVENTION

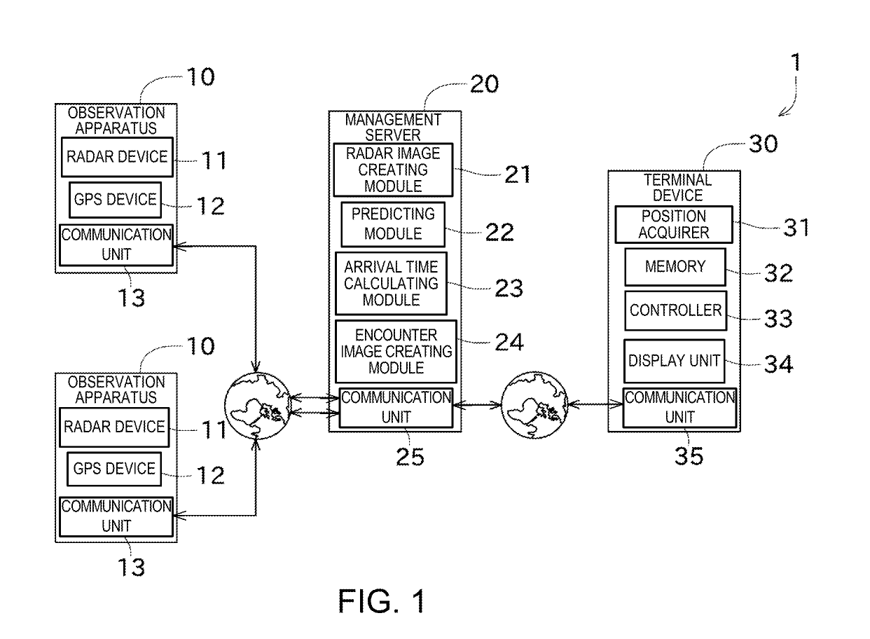

Next, an embodiment of this disclosure is described with reference to the drawings. FIG. 1 is a block diagram illustrating an overall configuration of a weather information display system 1.

The weather information display system 1 of this embodiment displays, on a terminal device 30 such as a smartphone possessed by a user, weather information by superimposing it on a map. Compared to the conventional configurations, the weather information display system 1 can provide detailed weather information (pinpoint weather information) of neighborhood of the user in real time. Moreover, an image indicating which moving direction allows avoiding the rain can be displayed.

Hereinafter, a specific configuration of the weather information display system 1 is described. As illustrated in FIG. 1, the weather information display system 1 includes observation apparatuses 10, a management server (management unit) 20, and the terminal device 30.

Each of the observation apparatuses 10 is installed on, for example, a rooftop of a building, and observes rain clouds, etc. within an area of about a few dozen km from the installation position. The observation apparatus 10 includes a radar device 11, a GPS device 12, and a communication unit 13. The observation apparatus 10 acquires weather observation data. The weather observation data is related to weather and contains rain information, thunder information, tornado information, etc. Note that, in FIG. 1, only two observation apparatuses 10 are illustrated; however, actually a larger number of observation apparatuses 10 constitute the weather information display system 1.

The radar device 11 includes a transceiver and a radar antenna. The transceiver can generate radio waves by a control circuit, a magnetron, etc. The radar antenna discharges outside the radio waves generated by the transceiver. The radio waves discharged from the radar antenna reflect on a rain drop, a rain cloud, etc. and are received by the radar antenna. By the transceiver, an amplification, a frequency down-conversion, etc. are performed on each of the reflection waves received by the radar antenna.

The following matters can be obtained based on the reflection wave. Specifically, a distance to the rain cloud, etc. can be obtained based on a time length from the transmission of the radio wave to the reception thereof by the radar antenna. Moreover, a direction in which the rain cloud, etc. exist can be obtained based on an elevation angle and an azimuth angle of the radar antenna when the radio wave is transmitted. Furthermore, when the elevation angle is increased, a position of the rain cloud in the air, an amount of water contained in the rain cloud, and the like can be obtained. On the other hand, when the elevation angle is reduced, an amount, size and the like of the rain drop that is actually currently falling can be obtained. Further, a velocity (speed and direction) of the rain cloud, etc. can be obtained by using that the frequency of the reflection wave is different depending on a difference in moving speed of the rain cloud, etc. (Doppler processing).

The GPS device (GNSS device) 12 includes a GPS antenna and a GPS receiver. The GPS receiver can calculate a position of the GPS device 12 by receiving and analyzing positioning signals from GPS satellites. Moreover, it is known that a time length until each positioning signal arrives is in a correlative relationship with an amount of water within air. In this embodiment, the amount of water within air is obtained based on the correlative relationship.

Note that, the processing of analyzing the reflection wave of the radar device 11, the processing of obtaining the amount of water based on the time length until the positioning signal arrives, etc. may be performed on the observation apparatus 10 side or the management server 20 side.

The communication unit 13 is able to communicate over internet, etc. and transmits, to the management server 20, either one of the weather observation data obtained by the radar device 11 and the GPS device 12 and data obtained by processing the weather observation data. Note that, alternative to the configuration in which the observation apparatus 10 transmits the weather observation data, etc. to the management server 20, a configuration in which the observation apparatus 10 transmits the weather observation data, etc. to the terminal device 30 may be adopted.

The management server 20 is installed in, for example, a company that provides the weather information display system 1. The management server 20 performs an overall control regarding the plurality of observation apparatuses 10, the terminal device 30, etc. The management server 20 includes a radar image creating module 21, a predicting module 22, an arrival time calculating module (calculator) 23, an encounter image creating module 24, and a communication unit 25.

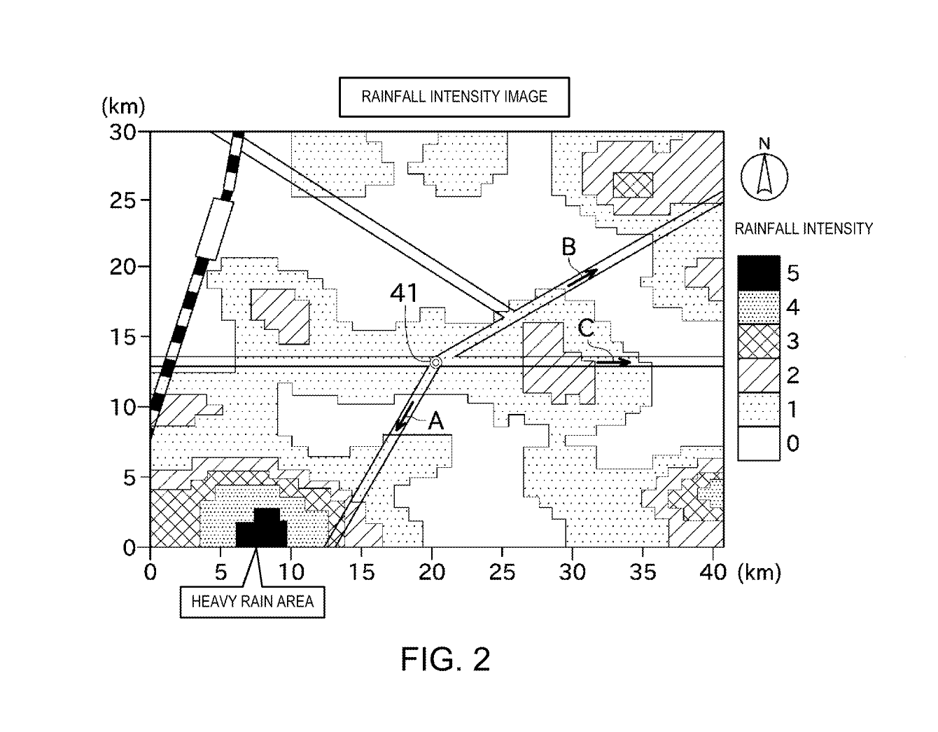

The radar image creating module 21 creates a weather radar image based on the weather observation data of the observation apparatuses 10. The weather radar image is a radar image created based on the reflection waves received by the radar device 11 (including at least one of the reflection wave when the elevation angle is large and the reflection wave when the elevation angle is small) (FIG. 2). Note that, in this embodiment, the position of the rain cloud and an approximate amount of rain which the rain cloud produces are displayed by the weather radar image, and therefore, the weather radar image may particularly be referred to as a rainfall intensity image.

The predicting module 22 predicts a change of the weather when a time point is shifted forward. Specifically, the predicting module 22 predicts a moving direction of the rain cloud based on the velocity of the rain cloud obtained from the Doppler processing. Moreover, the predicting module 22 predicts a developing status of the rain cloud based on the amount of water of the rain cloud acquired by the radar device 11, the amount of water acquired by the GPS device 12, etc. In this embodiment, since the movement of the rain cloud and the like are predicted based on a radar image at a current time point instead of a weather forecast performed before use as above, the prediction can be performed in real time. Further, in this embodiment, since the prediction is performed based on the position of the terminal device, a status of rain cloud around the terminal device, and the like instead of the prediction for a wide area (e.g., per city), a pinpoint prediction can be performed.

The arrival time calculating module 23 and the encounter image creating module 24 create a rain encounter image (encounter image). The rain encounter image is a view in which a certain point (e.g., a current position of the user) is used as a reference position to indicate which moving direction from the reference position does not include encountering the rain cloud. Note that, a method of creating the encounter image is described later.

The communication unit 25 can communicate with each observation apparatus 10 and the terminal device 30 over internet, etc. The management server 20 transmits, to the terminal device 30, the rainfall intensity image, the rain encounter image, etc.

The terminal device 30 is an instrument possessed by the user who uses the weather information display system 1 and, specifically, it is a mobile phone, a smartphone, a tablet terminal device, a human navigation device, etc. Note that, the human navigation device means a terminal device having a function for navigating either one of a person and a bicycle, and the concept of the human navigation device includes, not only a so-called navigation device (dedicated device), but also a smartphone installed with an application for navigation, etc. The terminal device 30 includes a position acquirer 31, a controller 33, a display unit 34, and a communication unit 35. Note that, only one terminal device 30 is illustrated in FIG. 1; however, actually a larger number of terminal devices 30 constitute the weather information display system 1.

The position acquirer 31 is configured with, for example, a GPS reception device, and can calculate a position of the terminal device 30 by receiving and analyzing the positioning signals from the GPS satellites. Moreover, the position acquirer 31 is not limited to have the configuration of utilizing the GPS satellites, and may have a configuration of acquiring the position based on, for example, identification information of a base station of a communication facility, or a configuration of acquiring the position based on, for example, an MAC address of a wireless LAN router.

The memory 32 stores data of an application of the weather information display system 1 on the terminal device 30 side (weather information display program), map information, etc. Note that, hereinafter, the application of the weather information display system 1 on the terminal device 30 side may simply be referred to as the application.

The controller 33 is configured with, for example, a CPU, and it controls the terminal device 30 according to an instruction from the user. For example, the controller 33 performs processing of executing the application of the weather information display system 1.

The display unit 34 is a display of, for example, a liquid crystal type or an organic-EL type, and it can display the images created by the management server 20, the controller 33, etc.

The communication unit 35 can transmit the position of the terminal device 30 to the management server 20 and receive the rainfall intensity image, the rain encounter image and the like from the management server 20.

Next, processing performed by the management server 20 and the controller 33 after activating the application is described.

The controller 33 acquires the position of the terminal device 30 from the position acquirer 31 after the application is activated. Then, the controller 33 transmits the position of the terminal device 30 to the management server 20 via the communication unit 35.

The management server 20 receives the position and creates the rainfall intensity image and the rain encounter image corresponding to the received position.

First, the rainfall intensity image is described. The management server 20 reads the rainfall intensity image for neighborhood of the position received from the terminal device 30, and transmits the image to the terminal device 30. Note that, the radar device 11 transmits the weather observation data to the management server 20 intermittently, and the radar image creating module 21 keeps creating (updating) the rainfall intensity image based on the weather observation data. Therefore, the management server 20 transmits the latest rainfall intensity image to the terminal device 30 at a timing of the update of the rainfall intensity image, etc.

The controller 33 reads the map information around the terminal device based on the position of the terminal device acquired by the position acquirer 31, and can display it on the display unit 34 along with the received rainfall intensity image.

FIG. 2 illustrates the rainfall intensity image to be displayed on the display unit 34. In FIG. 2, a reference position mark 41 indicating the position of the terminal device is displayed. Moreover, in the rainfall intensity image, a rainfall intensity is obtained based on an intensity of the reflection wave from the rain cloud, the amount of water contained in the rain cloud, an amount of rain drops, and the like. In FIG. 2, six levels of rainfall intensity from 0 to 5 are set, in which a higher rainfall intensity indicates that stronger rain occurs or there is a higher possibility of causing such rain.

As illustrated in FIG. 2, it can be understood that a heavy rain area in which the rainfall intensity is at level 5 exists on the south-west side by taking north on the upper side of FIG. 2. Moreover, it can also be understood that an area in which the rainfall intensity is at level 4 exists on the south-east side.

However, only from the rainfall intensity image, the movement of the heavy rain area (rain cloud) cannot be grasped. Therefore, which moving direction allows avoiding the heavy rain cannot be determined only from the rainfall intensity image.

In this embodiment, by considering such issue, the rain encounter image is created by the arrival time calculating module 23 and the encounter image creating module 24. As initial information (setting information) for creating the rain encounter image, the user can set the reference position, a user's speed (moving speed), a reference time point, etc.

The reference position is for determining which location to serve as a reference for creating the rain encounter image, and the position of the user received by the terminal device 30 is normally set as the reference position. Alternatively, a position specified by the user may be the reference position, for example. This is useful in a case where the user is currently on a train, and after arriving at a station, he/she returns home by a bicycle while avoiding the heavy rain, etc.

The user's speed is for determining which moving speed to create the rain encounter image for, and either one of a speed of a pedestrian (about 80 m per minute) and a speed of a bicycle (about 250 m per minute) is normally set as the user's speed. For the user's speed, a configuration in which the user selects either one of the speed of the pedestrian and the speed of the bicycle or a configuration in which the user inputs a specific numeric value may be adopted.

The reference time point is for determining which departing time point to create the rain encounter image for, and the current time point is normally used as the reference time point; however, a time point specified by the user may also be used. For example, in a case where the user requests to create the rain encounter image for after arriving at the station as described above, by using an arrival time point at the station as the reference time point, the rain encounter image of the user's request is created.

By taking the above setting values into consideration, the arrival time point calculating module 23 can calculate a time point of arriving (arrival time point) at each of a plurality of locations when linearly moving from the reference position. Specifically, a required period of time from the reference position to the location is obtained based on a distance from the reference position to the location and the user's speed, and the arrival time point is obtained by adding the required period of time to a departing time point.

Moreover, as described above, the predicting module 22 predicts a change of the rainfall intensity image when the time point is shifted forward. Therefore, for each location, the encounter image creating module 24 can obtain the rainfall intensity at the arrival time point at the location. The encounter image creating module 24 can create the rain encounter image by performing the calculation for a distance of a predetermined area and all directions from the reference position. Note that, the rain encounter information is not necessarily created for all directions, and a configuration of calculating only for a direction range specified by the user may be adopted, for example.

The management server 20 transmits the rain encounter image created as described above to the terminal device 30. The controller 33 can display the received rain encounter image on the display unit 34, along with a map around the terminal device.

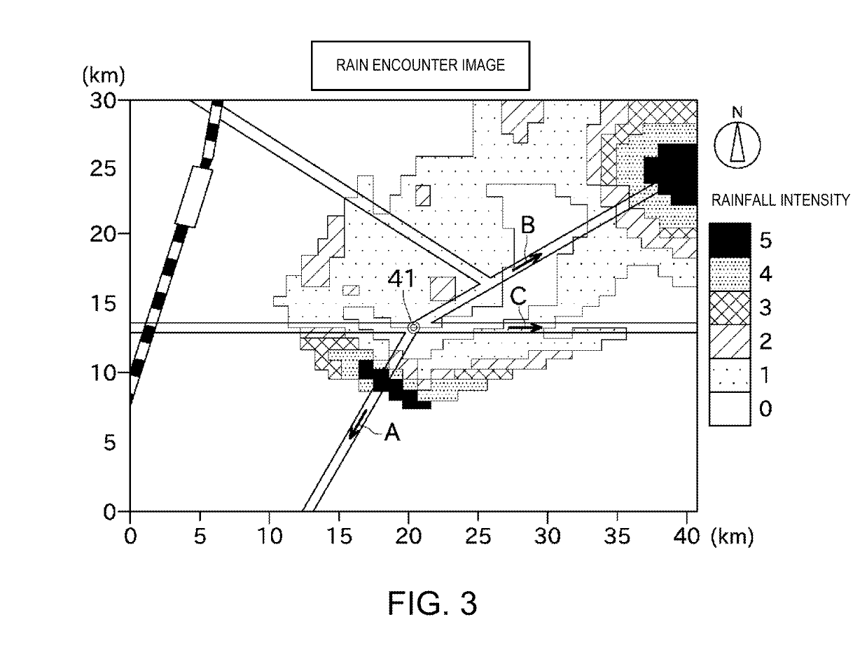

FIG. 3 illustrates the rain encounter image to be displayed on the display unit 34. Moreover, also in FIG. 3, similar to FIG. 2, the reference position mark 41 is displayed. By utilizing this rain encounter image, which moving direction causes encountering the heavy rain can be determined at a glance. Hereinafter, this is specifically described.

In FIGS. 2 and 3, routes from the reference position to three directions of A to C, are illustrated. With reference to FIG. 2, in the case of moving in the A direction, the moving direction is toward the heavy rain area. Here, a situation can be considered where the user does not encounter the heavy rain if the heavy rain moves to the north-west. Moreover, even in the case of encountering the heavy rain, since the location (spot) at which the user will encounter the heavy rain can be understood, a timing to take shelter from the rain, etc. can be assumed.

Here, with reference to FIG. 3, in the case of moving in the A direction, it can be understood only at a glance that the user will encounter the heavy rain at a location of approximately 5 km forward (i.e., the heavy rain area moves toward the user). Therefore, in the case of moving in the A direction, the user can avoid encountering the heavy rain by taking shelter from the rain before moving approximately 5 km forward.

Next, the case of moving in the B direction is considered. Also in the case of moving in the B direction, similar to the case of moving in the A direction, it is difficult to determine whether the user encounters the heavy rain by only referring to FIG. 2. However, with reference to FIG. 3, it can be understood only at a glance that the user will encounter the heavy rain at a location of approximately 20 km forward (i.e., the heavy rain area moves toward the user and its moving speed is slightly faster than the user's speed). Therefore, in the case of moving in the B direction, the user can avoid encountering the heavy rain by taking shelter from the rain before moving approximately 20 km forward or searching for a different route.

Next, the case of moving in the C direction is considered. Also in the case of moving in the C direction, similar to the cases of moving in the A and B directions, it is difficult to determine whether the user encounters the heavy rain by only referring to FIG. 2. However, with reference to FIG. 3, in the case of moving in the C direction, it can be understood only at a glance that the user will not encounter rain of which the rainfall intensity is at level 2 or higher.

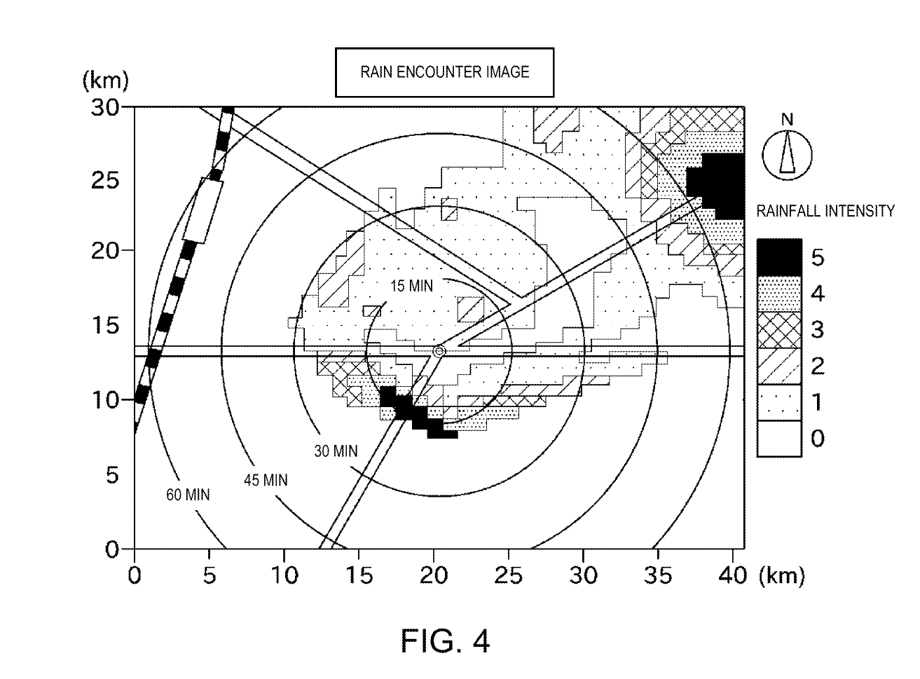

Thus, by utilizing the rain encounter image, how much rain to encounter and the location of the encounter can be grasped at a glance. Note that, at least one of the distance from the reference position, the required time period from the reference position, and the arrival time point may be displayed for the user to understand easier that in how many minutes he/she encounters the heavy rain. FIG. 4 displays a plurality of concentric circles centering on the reference position, and the required time period from the reference position is noted in each concentric circle.

As described above, the weather information display system 1 includes the radar device 11, the radar image creating module 21, the predicting module 22, the encounter image creating module 24, and the display unit 34. The radar device 11 acquires the weather observation data. The radar image creating module 21 creates the weather radar image (rainfall intensity image) based on the weather observation data. The predicting module 22 predicts the change of weather when the time point is shifted forward, based on the weather observation data. The encounter image creating module 24 creates, as the weather radar images for the respective locations, the encounter image displaying the weather radar images at the time points of arriving at the respective locations, based on the change of weather predicted by the predicting module 22 and either one of the time points of arriving at the respective locations and the required time periods to the locations. The display unit 34 is provided to the terminal device 30 and displays the encounter image by superimposing it on the map.

Thus, the user can grasp only at a glance which moving direction allows avoiding the encounter with rain, etc. Moreover, in this embodiment, since the pinpoint and extremely accurate prediction can be performed, the possibility of encountering rain, etc. can be predicted highly accurately.

Although the preferred embodiment of this disclosure is described above, the above configuration may be modified as follows.

The weather information display system 1 described above is an example, and a part of the processing performed by the observation apparatus 10 may be performed by either one of the management server 20 and the terminal device 30, a part of the processing performed by the management server 20 may be performed by either one of the observation apparatus 10 and the terminal device 30, or a part of the processing performed by the terminal device 30 may be performed by either one of the observation apparatus 10 and the management server 20.

In the above embodiment, the configuration in which the arrival time calculating module 23 calculates the arrival time points at the respective locations is adopted; however, instead of the arrival time points, a configuration of obtaining “periods of time required to move from the reference position (required periods of time)” may be adopted. Moreover, a configuration in which a required period of time is determined according to the distance from the reference position before use, and then the encounter image (rain encounter image) is created based on the required time period, may be adopted. In this case, the arrival time calculating module 23 can be omitted.

The above embodiment has the configuration of detecting the position and the amount of water within air based on the signals from the GPS satellites; however, it may suitably be changed as long as it is a configuration of utilizing a GNSS (Global Navigation Satellite System). For example, a configuration of performing similar processing based on signals from GLONASS satellites or GALILEO satellites may be adopted.

In the above description, this disclosure is applied to the system configured to navigate either one of pedestrians and bicycles; however, this disclosure may also be applied to navigation systems for vehicles, ships, etc.

### DESCRIPTION OF REFERENCE NUMERAL(S)

10 Observation Apparatus
11 Radar Device
12 GPS Device (GNSS Device)
13 Communication Unit
20 Management Server (Management Unit)
21 Radar Image Creating Module
22 Predicting Module
23 Arrival Time Calculating Module (Calculator)
24 Encounter Image Creating Module
25 Communication Unit
30 Terminal Device

1. A weather information display system, comprising:
a radar device configured to acquire weather observation data;
a radar image creator configured to create a weather radar image based on the weather observation data;
a predictor configured to predict a change of weather when a time point is shifted forward, based on the weather observation data;
an encountering image creator configured to create, as the weather radar images for respective locations, an encountering image displaying the weather radar images at arrival time points at the respective locations, based on the change of weather predicted by the predictor and either one of the arrival time points at the respective locations and required periods of time to reach the respective locations; and
a display unit provided to a terminal device and configured to display the encountering image by superimposing it on a map.

2. The weather information display system of claim 1, comprising:
a calculator configured to calculate the either one of the arrival time points at the respective locations and the required time periods to reach the respective locations in a case of moving in a predetermined direction from a reference position at a set speed,
wherein the encountering image creator creates the encountering image based on the change of weather predicted by the predictor and the either one of the arrival time points and the required time periods calculated by the calculator.

3. The weather information display system of claim 1, wherein the encountering image creator creates the encountering image for all directions with respect to the reference position.

4. The weather information display system claim 1, comprising:
a plurality number of the radar devices; and
a management unit configured to receive either one of the weather observation data and information obtained based on the weather observation data from the plurality number of the radar devices, and transmit the either one of the weather observation data and the information obtained based on the weather observation data, in response to a request from the terminal device.

5. The weather information display system of claim 1, wherein the calculator is able to accept a change of a moving speed from the reference position, for the creation of the encountering image, and
wherein the encountering image creator is able to create the encountering image based on the accepted moving speed.

6. The weather information display system of claim 1, wherein the calculator is able to accept a change of the reference position, for the creation of the encountering image, and
wherein the encountering image creator is able to create the encountering image based on the accepted reference position.

7. The weather information display system of claim 1, wherein the calculator is able to accept a change of a time point of starting the movement, for the creation of the encountering image, and
wherein the encountering image creator is able to create the encountering image based on the accepted time point.

8. The weather information display system of claim 1, comprising a position acquirer provided to the terminal device and configured to acquire a position of the terminal device,
wherein the encountering image creator creates the encountering image by using the position acquired by the position acquirer as the reference position.

9. The weather information display system of claim 1, wherein the display unit displays, for each of the locations, at least one of a distance from the reference position, the required time period from the reference position, and the arrival time point.

10. The weather information display system of claim 1, comprising a GNSS device configured to receive signals from GNSS satellites,
wherein the predictor predicts the change of the weather radar image when the time point is shifted forward, based on a detection result of the GNSS device and a detection result of the radar device.

11. A human navigation device, comprising:
a communication unit configured to receive, as weather radar images for respective locations, an encountering image displaying the weather radar images at arrival time points at the respective locations based on a change of weather when a time point is shifted forward and either one of the arrival time points at the respective locations and required periods of time to reach the respective locations, the encountering image created based on weather observation data acquired by a radar device;
a position acquirer configured to acquire a position of the human navigation device; and
a display unit configured to use the position acquired by the position acquirer as a reference position to display the reference position and the encountering image around the reference position by superimposing them on a map.

12. (canceled)

13. A method of displaying weather information, comprising:
acquiring weather observation data;
creating a weather radar image based on the weather observation data;
predicting a change of the weather radar image when a time point is shifted forward, based on the weather observation data;
creating, as the weather radar images for respective locations, an encountering image displaying the weather radar images at arrival time points at the respective locations, based on the change of weather predicted by the predicting the change of the weather radar image and either one of the arrival time points at the respective locations and required periods of time to reach the respective locations; and
displaying the encountering image by superimposing it on a map.
